(19) United States
(12) Patent Application Publication
(10) Pub. No.: US 2024/0343998 A1
(43) Pub. Date: Oct. 17, 2024

(54) ENZYMATIC DETERGENT COMPOSITION WITH AMINO ACID

(71) Applicant: Henkel AG & Co. KGaA, Duesseldorf (DE)

(72) Inventors: Daniel Thomas PIORKOWSKI, Fairfield, CT (US); Peter Schmiedel, Duesseldorf (DE)

(73) Assignee: Henkel AG & Co. KGaA, Duesseldorf (DE)

(21) Appl. No.: 18/617,190

(22) Filed: Mar. 26, 2024

Related U.S. Application Data
(60) Provisional application No. 63/495,458, filed on Apr. 11, 2023.

(51) Int. Cl. C11D 3/33; C11D 1/29; C11D 1/32; C11D 1/42; C11D 1/72; C11D 1/835; C11D 3/04; C11D 3/20; C11D 3/34; C11D 3/386

(52) U.S. Cl. CPC C11D 3/33; C11D 1/29; C11D 1/32; C11D 1/42; C11D 1/72; C11D 1/8355; C11D 3/044; C11D 3/2082; C11D 3/349; C11D 3/38618; C11D 3/38636; C11D 2111/12

(57) ABSTRACT

The present disclosure provides a detergent composition comprising water, at least one surfactant, at least one amino acid or a salt thereof, and at least one enzyme, wherein the detergent composition has a pH of greater than 7 to about 10. The composition can further comprise additional components, such as an anti-redeposition agent, bleaching agent, a bleach activator, a chelating agent, an additional chlorine scavenger, a biocide, an optical brightener, and a combination thereof. The detergent composition can scavenge chlorine to a concentration of 0 ppm in less than about 60 sec after contact with a 1 L water sample comprising up to 4 ppm chlorine.

### BACKGROUND

Municipal water originates from a variety of sources, such as lakes, rivers, reservoirs, and wells. To make the water drinkable, chlorine can be added as a disinfectant. A concentration up to 4 ppm chlorine is typically the maximum allowed in municipal water, as suggested by the Centers for Disease Control and Prevention.

However, chlorine is known to deteriorate a fabric's dye over time, particularly red, blue, or black dyes. If not controlled, this dye deterioration generally will be seen in about 3 to 30 washes. In addition to fabric dye damage, chlorine in the water can negatively impact an enzyme's performance for cleaning soiled laundry. Monoethanolamine can be used in a detergent composition as a pH buffer and a chlorine scavenger. Triethanolamine can be added as a pH buffer. However, these amines are not yet certified as Safer Choice labeling designation by the U.S. Environmental Protection Agency (EPA).

Since there is a consumer push for improving detergent sustainability, there is a need for a detergent composition that can effectively clean textiles while scavenging chlorine to protect fabric dyes and enzyme activity by incorporating more Safer Choice ingredients.

### BRIEF SUMMARY

The present disclosure relates to a detergent composition comprising water, at least one surfactant, at least one amino acid or a salt thereof, and at least one enzyme, wherein the detergent composition has a pH of greater than 7 to about 10. In some aspects, the detergent composition has a pH of about 8 to about 10.

In some aspects, the at least one amino acid is selected from alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, any salt thereof, and a combination thereof. In some aspects, the at least one amino acid has a charged side chain or a polar uncharged side chain. In some aspects, the at least one amino acid is lysine, threonine, any salt thereof, or a combination of lysine and threonine including salts thereof.

In some aspects, the at least one surfactant is an anionic surfactant, a cationic surfactant, a zwitterionic surfactant, a nonionic surfactant, or a combination thereof.

In some aspects, the anionic surfactant comprises an alkyl sulfate, an alkyl sulfonate, a fatty acid salt, a bile acid salt, a glutamic acid salt, a cholic acid salt, a carboxylic poly(ethylene glycol) ether, a taurate, or a combination thereof. In some aspects, the cationic surfactant comprises a fatty amine salt, a fatty diamine salt, a coco amine alkoxylate, an alkoxylated amine, an alkoxylated diamine, fatty quaternary ammonium compound, a fatty amide quaternary ammonium compound, an alkoxylated quaternary ammonium compound, a benzalkyl quaternary ammonium compound, or a combination thereof. In some aspects, the zwitterionic surfactant comprises a betaine, a sulfonated quaternary ammonium compound, a phosphonated quaternary ammonium compound, a trialkylamine N-oxide, or a combination thereof. In some aspects, the nonionic surfactant comprises the nonionic surfactant comprises a fatty alcohol alkoxylate, a fatty acid alkoxylate, an alkyl phenol ethoxylate, an alkoxylated amine, an alkyl glucoside, a fatty amide alkoxylate, a diester of alkoxylated fatty acid, an alkoxylated methyl ester of fatty acid, a glycerol fatty ester, castor oil alkoxylate, an ethylene oxide-propylene oxide block copolymer, a phenol alkoxylate, or a combination thereof.

In some aspects, the at least one enzyme comprises a protease, an amylase, a mannanase, a lactase, a lipase, a perhydrolase, an oxidoreductase, or a combination thereof.

In some aspects, the composition further comprises an acid, a base, or combination of an acid and a base. In some aspects, the acid is an organic acid. In some aspects, the organic acid comprises citric acid. In some aspects, the base is a Group I hydroxide, a Group II hydroxide, monoethanolamine, diethanolamine, triethanolamine, methyl diethanolamine, sodium tetraborate, trisodium phosphate, sodium carbonate, or a combination thereof. In other aspects, the base is a Group I hydroxide, a Group II hydroxide, sodium tetraborate, trisodium phosphate, sodium carbonate, or a combination thereof.

In some aspects, the composition further comprises at least one additive selected from an anti-redeposition agent, bleaching agent, a bleach activator, a chelating agent, an additional chlorine scavenger, a biocide, an optical brightener, and a combination thereof.

In some aspects, the bleaching agent comprises at least one inorganic perhydrate salt comprising a perborate salt, a percarbonate salt, a perphosphate salt, a persulfate salt, a persilicate salt, or a combination thereof.

In some aspects, the detergent composition comprises water, at least one anionic surfactant, at least one nonionic surfactant, at least one amino acid or salt thereof, at least one enzyme, an acid, a base, a biocide, and a chelating agent.

In some aspects, the detergent composition comprises water, at least one surfactant selected from sodium lauryl sulfate, a linear alkyl benzene sulfonate, an alcohol ethoxysulfate, a methyl ester sulfonate, a fatty alcohol ethoxylate, an alkoxylated methyl ester of fatty acid (e.g., a methyl ester ethoxylate), and coco fatty acid, lysine or a salt thereof, at least one enzyme, citric acid, sodium hydroxide, a biocide, and tetrasodium glutamate diacetate.

In some aspects, the detergent composition scavenges chlorine to a concentration of 0 ppm in less than about 60 sec after contact with a 1 L water sample comprising up to 4 ppm chlorine.

### BRIEF DESCRIPTION OF THE DRAWING/FIGURE

FIG. 1 is a titration graph of pH versus amount of 50% NaOH solution (g) for triethanolamine (TEA) (●) and lysine (▴).

### DETAILED DESCRIPTION

Provided herein is a detergent composition comprising water, at least one surfactant, at least one amino acid or a salt thereof, and at least one enzyme, wherein the detergent composition has a pH of greater than 7 to about 10.

Non-limiting examples of the various aspects are shown in the present disclosure.

### Definitions

In order that the present disclosure can be more readily understood, certain terms are first defined. Additional definitions are set forth throughout the detailed disclosure.

All of the various aspects, embodiments, and options disclosed herein can be combined in any and all variants unless otherwise specified. Terms in this application control in the event of a conflict with a patent or publication term that is incorporated by reference.

As used herein, “a,” “an,” or “the” means one or more unless otherwise specified.

Furthermore, “and/or,” where used herein, is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

Open terms such as “include,” “including,” “contain,” “containing” and the like mean “comprising.” The term “or” can be conjunctive or disjunctive.

It is understood that wherever aspects are described herein with the language “comprising,” otherwise analogous aspects described in terms of “consisting of” and/or “consisting essentially of” are also provided.

Some inventive embodiments contemplate numerical ranges. Every numerical range provided herein includes the range endpoints as individual inventive embodiments. When a numerical range is provided, all individual values and sub-ranges therein are present as if explicitly written out.

The term “about” includes the recited number ±10%. For example, “about 10” means 9 to 11.

The phrase “substantially free of” means that a composition contains little or no specified ingredient/component, such as less than about 5 wt %, less than about 4 wt %, less than about 3 wt %, less than about 2 wt %, less than about 1 wt %, less than about 0.5 wt %, less than about 0.3 wt %, less than about 0.2 wt %, less than about 0.1 wt %, or about 0 wt % of the specified ingredient.

As used herein, the “%” described in the present application refers to the weight percentage unless otherwise indicated.

The term “at least” prior to a number or series of numbers is understood to include the number adjacent to the term “at least,” and all subsequent numbers or integers that could logically be included, as clear from context. For example, “at least one enzyme” means that 1, 2, 3, or more enzymes are included in the composition. When at least is present before a series of numbers or a range, it is understood that “at least” can modify each of the numbers in the series or range. “At least” is also not limited to integers (e.g., “at least 5%” includes 5.0%, 5.1%, 5.18% without consideration of the number of significant FIGURES).

Unless states otherwise, the term “by weight of the composition” refers to a composition of a final product derived from a process, unless otherwise defined.

The terms “process” and “method” can be used interchangeably.

“Alkoxylate” or “alkoxylated” as used in the present application means: the presence of an polyaliphatic ether moiety in a compound, such as ethoxylate (—CH₂CH₂O—) or propoxylate (—CH(CH₃)CH₂O—). A polyethoxylate is multiple repeat units of ethoxylate ((—CH₂CH₂O—)ₙ), and a polypropoxylate is multiple repeat units of propoxylate ((—CH(CH₃)CH₂O—)ₘ). The subscripts “n” and “m” are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

“Amylases” as used in the present application means: class of enzymes that catalyze the hydrolysis of starch into sugars such as glucose and maltose.

“Cellulase” as used in the present application means: class of enzymes that catalyze the cellylolysis or hydrolysis of cellulose.

“Endocellulases” as used in the present application means: class of cellulases that hydrolyze glycoside links within cellulose chains.

“Exocellulases” as used in the present application means: class of cellulases that hydrolyze glycoside links at the ends of cellulose chains.

“Lipases” as used in the present application means: class of enzymes that catalyze the hydrolysis of fats or lipids.

“Mannanases” as used in the present application means: class of enzymes that catalyze the hydrolysis of mannose derivatives.

“Mannose” as used in the present application means: sugar monomer of the aldohexose series of carbohydrates.

“Proteases” as used in the present application means: class of enzymes that catalyze the hydrolysis of proteins.

### Detergent Composition

In some aspects, the present disclosure is directed to a detergent composition comprising water, at least one surfactant, at least one amino acid or a salt thereof, and at least one enzyme, wherein the detergent composition has a pH of greater than 7 to about 10.

The present disclosure is predicated on the discovery that an amino acid can be used in a detergent (e.g., liquid detergent) as a chlorine scavenger and, in some circumstances, a pH buffer. As an added benefit, the use of an amino acid is environmentally friendly, helping to provide a Safer Choice labeling designation by the U.S. EPA.

The detergent composition comprises at least one (e.g., 1, 2, 3, 4, 5, or 6, etc.) amino acid to act as a chlorine scavenger. In some aspects, the at least one amino acid further acts as a pH buffer. In some aspects, the at least one amino acid is a naturally occurring amino acid, including one of the 20 naturally occurring amino acids (e.g., alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, any salt thereof, or any combination thereof). In some aspects, the amino acid has a charged side chain (e.g., arginine, aspartic acid, glutamic acid, histidine, or lysine). In some aspects, the at least one amino acid has a polar uncharged side chain (e.g., serine, threonine, asparagine, or glutamine). In the aspects, the at least one amino acid has a hydrophobic side chain (e.g., alanine, valine, isoleucine, leucine, methionine, phenylalanine, tyrosine, or tryptophan). In some aspects, the at least one amino acid is cysteine, glycine, or proline. In some aspects, the at least one amino acid has a charged side chain or a polar uncharged side chain. In some aspects, the at least one amino acid is in the form of a salt, e.g., lysine hydrochloride.

In some aspects, the detergent composition comprises one or two amino acids, but in some aspects, the detergent composition comprises one amino acid. In some aspects, the at least one amino acid is lysine, threonine, any salt thereof, or a combination of lysine and threonine including salts thereof. In some aspects, the detergent composition comprises lysine or a salt thereof (e.g., lysine hydrochloride).

In some aspects, the detergent composition comprises from about 0.001 wt % to about 5 wt % of total amount of at least one amino acid (e.g., lysine, threonine, any salt thereof, or a combination of both) relative to the total weight of the composition. For example, the total amino acid content can be from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the detergent composition.

In some aspects, the at least one (e.g., 1, 2, 3, 4, 5, or 6, etc.) surfactant is an anionic surfactant, a cationic surfactant, a zwitterionic surfactant, a nonionic surfactant, or a combination thereof. For example, the detergent composition can comprise a combination of anionic surfactants and nonionic surfactants.

The anionic surfactant comprises a hydrophobic tail group (e.g., a linear aliphatic chain) and an anionic hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl), alkyl, or fluoro (e.g., perfluorinated). The anionic hydrophilic group can be, for example, a sulfate (—OSO₃⁻), sulfonate (—SO₃⁻), a phosphate (—OPO₃³⁻), a carboxylate (—C(O)O⁻), or the conjugate base of an organic acid. In some aspects, polyethylene glycol repeat units designated as “ether” can be disposed between the hydrophobic tail group (e.g., a fatty group) and hydrophobic head group.

In some aspects, the anionic surfactant comprises an alkyl sulfate, an alkyl sulfonate, a fatty acid salt, a bile acid salt, a glutamic acid salt, a cholic acid salt, a carboxylic poly(ethylene glycol) ether, a taurate, or a combination thereof. Typically, the salt will be a Group I (e.g., lithium, sodium, potassium, etc.), Group II (e.g., magnesium, calcium, etc.), or ammonium salt.

Examples of an alkyl sulfate include, e.g., a fatty sulfate (e.g., octylsulfate, decyl sulfate, lauryl (dodecyl) sulfate, myristyl sulfate), dioctyl sodium sulfosuccinate, and an alcohol ethoxysulfate with the structure R¹—O-(EO)ₙSO₃Na, in which R¹ is a C₈-C₁₈ alkyl group (linear or branched), EO is polyethylene oxide, n is typically 1 to 8 (e.g., lauryl ether sulfate). Other examples of fatty sulfate include, e.g., 3-sulfopropyl ethoxylate laurylphenyl ether and coco (coconut fatty acid) sulfate. Examples of an alkyl sulfonate include, e.g., a linear alkylbenzene sulfonate (e.g., sodium laurylbenzene sulfonate), a perfluoroalkyl sulfonate (e.g., perfluorooctyl sulfonate, perfluorobutyl sulfonate), and a methyl ester sulfonate. Examples of a fatty acid salt include, e.g., a caprylate, a laurate, a palmitate, a myristate, and a stearate. Other anionic surfactants include a bile acid salt, a glutamic acid salt (e.g., N-myristoly-1-glutamic acid), a glycolic acid salt, a cholic acid salt, a carboxylic poly(ethylene glycol) ether (e.g., glycolic acid ethoxylate laurylphenyl ether, glycolic acid ethoxylate oleyl ether), a taurate (e.g., sodium oleic acid methyl taurate, sodium coconut fatty acid methyl taurate, sodium cocyl methyl taurate), or a combination thereof.

In some aspects, the anionic surfactant comprises an alkyl sulfate (e.g., a lauryl sulfate), a coco fatty acid, a linear alkylbenzene sulfonate, an alcohol ethoxysulfate, a methyl ester sulfonate, or a combination thereof. In some aspects, the anionic surfactant comprises a linear alkylbenzene sulfonate, an alcohol ethoxysulfate, a methyl ester sulfonate, or a combination thereof.

The linear alkylbenzene sulfonate can have the structure of formula (I):

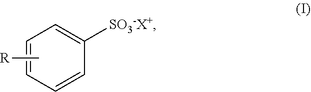

in which R is a linear C₁₀-C₁₈ (e.g., C₁₀, C₁₁, C₁₂, C₁₃, C₁₄, C₁₅, C₁₆, C₁₇, and C₁₈) alkyl, and X⁺ is a cation that balances the charge of the sulfonate. The benzylsulfonate can be at any suitable position (e.g., at the 1-position, 2-position, 3-position, 4-position, 5-position, 6-position, 7-position, 8-position, or 9-position) on the alkyl R. With respect to the benzene ring, the alkyl R and sulfonate can be ortho, meta, or para to each other. In some aspects, the alkyl R and sulfonate are para to one another.

In general, the methyl ester sulfonate can have the structure of formula (II):

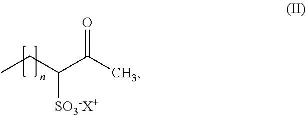

in which n is 10 to 16 (e.g., 10, 11, 12, 13, 14, 15, or 16) to form a C₁₂-C₁₈ alkyl (e.g., C₁₂, C₁₃, C₁₄, C₁₅, C₁₆, C₁₇, and C₁₈) and X⁺ is a cation that balances the charge of the sulfonate.

In some aspects, the cation X⁺ can be of formula (I) and/or (II) is a Group I cation, such as sodium cation or potassium cation, particularly sodium cation. In some aspects, the anionic surfactant comprises a methyl ester sulfonate.

The cationic surfactant comprises a hydrophobic tail group (e.g., a linear aliphatic chain) and a cationic hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The cationic hydrophilic group can be, for example, an amino group that can be quaternized, such as trialkylammonium. The counterion can be any suitable anion that can balance the charge. In some aspects, the counterion is an anion with a −1 charge (e.g., X⁻), such as a halide (e.g., chloride, bromide, etc.), hydroxy, or tosylate.

In some aspects, the surfactant can be alkoxylated, in which polyalkylene glycol (e.g., polyethylene glycol, polypropylene glycol) repeat units can be disposed between the hydrophobic tail group (e.g., a fatty group) and hydrophobic head group.

In some aspects, the cationic surfactant can be a fatty amine salt or a quaternary ammonium compound. In some aspects, the cationic surfactant comprises a fatty amine salt, a fatty diamine salt, a coco amine alkoxylate, an alkoxylated amine, an alkoxylated diamine, fatty quaternary ammonium compound, a fatty amide quaternary ammonium compound, an alkoxylated quaternary ammonium compound, a benzalkyl quaternary ammonium compound, or a combination thereof. Examples of the fatty amine salt include, e.g., a C₈-C₁₈ fatty amine salt (e.g., R¹—NH₃⁺, in which R¹ is a C₈-C₁₈ alkyl group). Examples of a fatty diamine salt include, e.g., R¹—NH₂⁺—R²—NH₃⁺, in which R¹ is a C₈-C₁₈ alkyl group and R² is a C₁₋₆ alkyl). Examples of an alkoxylated amine and an alkoxylated diamine include a polyethoxylated fatty amine and diamine, respectively. Examples of a fatty quaternary ammonium compound include, e.g., R¹—NR₃⁺, in which R¹ is a C₈-C₁₈ alkyl group and each R³ is a C₁₋₄ alkyl, phenyl, or benzyl (e.g., alkyltrimethylammonium halide, alkyltrimethylammonium tosylate, alkyltrimethylammonium hydroxide). Examples of a fatty amide quaternary ammonium compound include, e.g., R¹—C(O)N—R²—NR³₃⁺, in which R¹ is a C₈-C₁₈ alkyl group, R² is a C₁₋₆ alkyl, and each R³ is a C₁₋₄ alkyl, phenyl, or benzyl (e.g., trimethylammonium stearamide). Examples of an alkoxylated quaternary ammonium compound include, e.g., a polyethoxylated quaternary ammonium compound. Examples of a benzalkyl quaternary ammonium compound include, e.g., benzyl-C₈-C₁₈ alkyldimethylammonium (e.g, benzalkonium chloride).

The zwitterionic surfactant is amphoteric and can comprise a hydrophobic tail group (e.g., a linear aliphatic chain) and a hydrophilic head group with both a cationic charge and an anionic charge. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The cationic moiety can be, for example, a quaternary ammonium group, such as dialkylammonium or trialkylammonium (e.g., C₁-C₄ alkyl, such as methyl). The anionic moiety can be, for example, oxo (O⁻), a sulfate (—OSO₃⁻), sulfonate (—SO₃⁻), a phosphate (—OPO₃³⁻), a carboxylate (—C(O)O⁻), or the conjugate base of an organic acid.

In some aspects, the zwitterionic surfactant comprises a betaine, a sulfonated quaternary ammonium compound, a phosphonated quaternary ammonium compound, a trialkylamine N-oxide, or a combination thereof.

Examples of a betaine include, e.g., C₈-C₁₈ alkyl betaine, cocobetaine, cocamidopropyl betaine, amidosulfobetaine-16, hexadecyl hydroxypropyl sulfobetaine, lauryl-N,N-(dimethylammonio)butyrate, and lauryl-N,N-(dimethyl)-glycinebetaine. Examples of a sulfonated quaternary ammonium compound include, e.g., 3-(N,N-dimethyl-octylammonio)propanesulfonate, 4-(N,N-dimethyl-dodecylammonio)butanesulfonate, 3-{N,N-dimethyl-N-[3-(4-octylbenzoylamino)propyl]ammonio} propanesulfonate, 3-[(3-cholamidopropyl)dimethylammonio]-1-propanesulfonate, 3-([3-cholamidopropyl]dimethylammonio)-2-hydroxy-1-propanesulfonate, coco(amidopropyl)dimethylammonio-2-hydroxypropanesulonate, lauryl-N,N-(dimethylammonio)butyrate, lauryl-N,N-(dimethyl)-propanesulfonate, 3-(4-tert-butyl-1-pyridinio)-1-propanesulfonate, 3-(1-pyridinio)-1-propanesulfonate, and 3-(benzyl-dimethylammonio)propanesulfonate. Examples of a phosphonated quaternary ammonium compound include, e.g., a phosphocholine, such as N-dodecylphosphocholine and hexadecyl phosphocholine. Examples of a trialkylamine N-oxide include, e.g., R¹—N(O⁻)R²₂⁺, in which R¹ is a C₈-C₁₈ alkyl group, R² is a C₁₋₄ alkyl, such as lauryldimethylamine N-oxide and 4-ethyl-N,N-2-trimethyloctan-1-amine oxide.

The nonionic surfactant comprises a hydrophobic tail group (e.g., a linear aliphatic chain) and an uncharged (i.e., neutral) hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The uncharged hydrophilic group can be, for example, an alkoxylate, such as ethoxylate ((—CH₂CH₂O—)ₙ; EO or PEO) or propoxylate ((—CH(CH₃)CH₂O—)ₘ; PO or PPO), in which n and m are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

In some aspects, the nonionic surfactant comprises a fatty alcohol alkoxylate, a fatty acid alkoxylate, an alkyl phenol ethoxylate, an alkoxylated amine, an alkyl glucoside, a fatty amide alkoxylate, a diester of alkoxylated fatty acid, an alkoxylated methyl ester of fatty acid (e.g., a methyl ester ethoxylate), a glycerol fatty ester, castor oil alkoxylate, an ethylene oxide-propylene oxide block copolymer, a phenol alkoxylate, or a combination thereof.

Examples of a fatty alcohol alkoxylate include, e.g., C₈-C₁₈ ethoxylate and C₈-C₁₈ propoxylate. Examples of a fatty acid alkoxylate include, e.g., R¹—C(O)O-EO-H, in which R¹ is a C₈-C₁₈ alkyl group and EO is polyethylene oxide. Examples of an alkyl phenol ethoxylate include, e.g., R¹-phenyl-O(EO)—H, in which R¹ is a C₈-C₁₈ alkyl group and EO is polyethylene oxide. Examples of an alkoxylated amine include, e.g., ethoxylated C₈-C₁₈ alkylamine, tallow amine ethoxylate, lauryl amine ethoxylate ether, 2-2-(2-hydroxyethoxy)ethylaminoethanol, bis(hydroxyethoxyethyl)amine, 2,2′-((2-(2-hydroxyethoxy)ethyl)azanediyl)diethanol, and coco bis(2-hydroxyethyl) amine. Example of an alkyl glucoside include, e.g., alkyl polyglucoside, such as C₈-C₁₈ polyglucoside which can include 1 to 3 glucoside units. Examples of a fatty amide alkoxylate include R¹—C(O)NH-(EO)—H, in which R¹ is a C₈-C₁₈ alkyl group and EO is polyethylene oxide. Examples of a diester of alkoxylated fatty acid include, e.g., R¹—C(O)O-EO—C(O)—R^{1′}, in which R¹ and R^{1′} is a C₈-C₁₈ alkyl group and EO is polyethylene oxide. Examples of an alkoxylated methyl ester of fatty acid (e.g., a methyl ester ethoxylate) include e.g., R¹—C(O)O-EO-R², in which R¹ is a C₈-C₁₈ alkyl group, R² is a C₁-C₄ alkyl group, and EO is polyethylene oxide. Examples of a glycerol fatty ester include, e.g., an ester formed from glycerol and a fatty acid (e.g., C₈-C₁₈ alkyl), such as 2-ethylhexyl oleate, glycerol trioleate, glyceryl monooleate, glyceryl monotallate, n-butyl stearate, neopentylglycol dioleate, pentaerythritol monooleate, pentaerythritol tetraoleate, and trimethylolpropane trioleate. An example of a castor oil alkoxylate is polyethoxylated castor oil. Examples of an ethylene oxide-propylene oxide block copolymer include, e.g., R³O-(EO)ₙ—(PO)ₘ-(EO)ₙ—R⁴, in which R³ and R⁴ are the same or different and each is a C₁-C₇ alkyl, a C₅-C₆cycloalkyl, or an aryl; n is an integer of 30-150 (e.g., about 40-135, about 42-133), and m is an integer of about 10-100 (e.g., about 10-80, about 20-70, about 21-68) and block copolymers such as, PEO-PPO-PEO and PPO-PEO-PPO. Examples of a phenol alkoxylate include, e.g., R⁵—C₆H₄-(EO)—H, wherein R⁵ is hydrogen or a C₁-C₁₈ alkyl group, and EO is polyethylene oxide, such as octyphenol ethoxylate, nonylphenol ethoxylate, 2-phenoxydecan-1-ol, bisphenol ethoxylate, and a styrenated phenol ethoxylate (e.g., tristyrylphenol ethoxylate).

In some aspects, the nonionic surfactant comprises a fatty alcohol ethoxylate as a nonionic surfactant. In general, the fatty alcohol ethoxylate will have a chemical structure of formula (III):

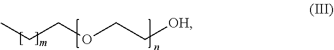

in which m is an integer of 10 to 16 (e.g., 10, 11, 12, 13, 14, 15, or 16) to form a C₁₂-C₁₈ fatty alkyl (e.g., C₁₂, C₁₃, C₁₄, C₁₅, C₁₆, C₁₇, and C₁₈), and n is an integer of 1 to 15 (e.g., 1, 2, 3, 4, 5, 6, 7, 8, 9, 10, 11, 12, 13, 14, or 15). The fatty alcohol ethoxylate typically will contain a range of alkyl groups, such as C₁₂-C₁₅ or C₁₂-C₁₄ and can contain branches. In some aspects, the fatty alcohol ethoxylate can contain 1 to 15 moles (e.g., 1 to 12 moles, 1 to 9 moles, 1 to 7 moles, or about 7 moles) of ethoxylate per mole of alcohol. In some aspects, the fatty alcohol ethoxylate can be a C₁₂-C₁₈ fatty alcohol ethoxylate with 1-15 moles of ethoxylate. In some aspects, the fatty alcohol ethoxylate comprises a C₁₂-C₁₅ fatty alcohol ethoxylate with 7 moles of ethoxylate. In some aspects, the fatty alcohol ethoxylate comprises ethoxylated lauryl alcohol.

In some aspects, the detergent composition comprises at least one anionic surfactant and at least one nonionic surfactant. In some aspects, the detergent composition can comprise at least one (e.g., 1, 2, 3, 4, 5, or 6, etc.) surfactant selected from an alkyl sulfate (e.g., sodium lauryl sulfate), an alcohol ethoxysulfate, a methyl ester sulfonate, a fatty alcohol ethoxylate (e.g., ethoxylated lauryl alcohol), a linear alkyl benzene sulfonate, an alkoxylated methyl ester of fatty acid (e.g., a methyl ester ethoxylate), and coco fatty acid.

In some aspects, the detergent composition comprises from about 3 wt % to about 65 wt % of at least one surfactant (e.g., an anionic surfactant, a cationic surfactant, a zwitterionic surfactant, a nonionic surfactant, or a combination thereof) relative to the total weight of the composition. For example, the total surfactant content can be present in an amount from about 3 wt % to about 60 wt %, about 3 wt % to about 55 wt %, about 3 wt % to about 50 wt %, about 5 wt % to about 65 wt %, about 5 wt % to about 60 wt %, about 5 wt % to about 55 wt %, about 5 wt % to about 50 wt %, about 10 wt % to about 65 wt %, about 10 wt % to about 60 wt %, about 10 wt % to about 55 wt %, about 10 wt % to about 50 wt %, about 12 wt % to about 65 wt %, about 12 wt % to about 60 wt %, about 12 wt % to about 55 wt %, about 12 wt % to about 50 wt %, about 15 wt % to about 65 wt %, about 15 wt % to about 60 wt %, about 15 wt % to about 55 wt %, about 15 wt % to about 50 wt %, about 18 wt % to about 65 wt %, about 18 wt % to about 60 wt %, about 18 wt % to about 55 wt %, about 18 wt % to about 50 wt %, about 20 wt % to about 65 wt %, about 20 wt % to about 60 wt %, about 20 wt % to about 55 wt %, about 20 wt %, about 50 wt %, about 22 wt % to about 65 wt %, about 22 wt % to about 60 wt %, about 22 wt % to about 55 wt %, about 22 wt % to about 50 wt %, about 24 wt % to about 65 wt %, about 24 wt % to about 60 wt %, about 24 wt % to about 55 wt %, about 24 wt % to about 50 wt %, about 26 wt % to about 65 wt %, about 26 wt % to about 60 wt %, about 26 wt % to about 55 wt %, about 26 wt % to about 50 wt %, about 28 wt % to about 65 wt %, about 28 wt % to about 60 wt %, about 28 wt % to about 55 wt %, about 28 wt % to about 50 wt %, about 30 wt % to about 65 wt %, about 30 wt % to about 60 wt %, about 30 wt % to about 55 wt %, about 30 wt % to about 50 wt %, about 3 wt % to about 25 wt %, about 3 wt % to about 20 wt %, about 5 wt % to about 25 wt %, about 5 wt % to about 20 wt %, about 10 wt %, about 25 wt %, about 10 wt %, about 25 wt %, about 65 wt %, about 60 wt %, about 55 wt %, about 50 wt %, about 48 wt %, about 46 wt %, about 44 wt %, about 42 wt %, about 40 wt %, about 38 wt %, about 36 wt %, about 34 wt %, about 32 wt %, about 30 wt %, about 28 wt %, about 26 wt %, about 24 wt %, about 22 wt %, about 20 wt %, about 18 wt %, about 16 wt %, about 14 wt %, about 12 wt %, about 10 wt %, about 8 wt %, about 6 wt %, about 5 wt %, about 4 wt %, or about 3 wt % of the total weight of the composition.

In some aspects, the detergent composition further comprises at least one (e.g., 1, 2, 3, 4, 5, or 6, etc.) enzyme to aid in removing stains, including protein stains, oil stains, tannin stains, starch stains, and dyes. For example, a protease is capable of breaking down protein-based stains, such as sweat, blood, mud, and dairy products. An amylase is capable of breaking down a starch-based stain, such as cornstarch or potato starch. A lipase is capable of breaking down fats. A mannanase is capable of breaking down guar and locust bean stains. In some aspects, the at least one enzyme is a hydrolytic enzyme. The at least one enzyme can comprise a protease, an amylase, a mannanase, a lactase, a lipase, a perhydrolase, an oxidoreductase, an endocellulase, an exocellulase, or a combination thereof. In some aspects, the detergent composition comprises a protease, an amylase, a mannanase, or a combination thereof.

In some aspects, the detergent composition comprises a total from about 0.01 wt % to about 5 wt % of at least one enzyme (e.g., a protease, an amylase, a mannanse, or a combination thereof) relative to the total weight of the composition. For example, the total enzyme content can from about 0.01 wt % to about 4 wt %, about 0.01 wt % to about 3 wt %, about 0.01 wt % to about 2 wt %, about 0.01 wt % to about 1 wt %, about 0.05 wt % to about 5 wt %, about 0.05 wt % to about 4 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.5 wt % to about 5 wt %, about 0.5 wt % to about 3 wt %, about 0.5 wt % to about 2 wt %, about 0.5 wt % to about 1 wt %, about 1 wt % to about 5 wt %, about 1 wt % to about 4 wt %, about 1 wt % to about 3 wt %, about 1 wt % to about 2 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.2 wt %, about 4.5 wt %, about 4.8 wt %, or about 5 wt % of the total weight of the composition.

The detergent composition has an alkaline pH, i.e., a pH of greater than 7 to about 10. In some aspects, the detergent composition has a pH of about 7.1 (e.g., about 7.2, about 7.3, about 7.4, about 7.5, about 7.6, about 7.7, about 7.8, or about 7.9) to about 10. In some aspects, the detergent composition has a pH of about 7.2 to about 10 (e.g., about 7.5 to about 10, about 8 to about 10, or about 8.5 to about 10) or about 7.5 to about 9.5 (e.g., about 7.5 to 9, or about 8 to about 9). In some aspects, the detergent composition has a pH of about 7.1, about 7.2, about 7.3, about 7.4, about 7.5, about 7.6, about 7.7, about 7.8, about 7.9, about 8, about 8.1, about 8.2, about 8.3, about 8.4, about 8.5, about 8.6, about 8.7, about 8.8, about 8.9, about 9, about 9.1, about 9.2, about 9.3, about 9.4, about 9.5, about 9.6, about 9.7, about 9.8, about 9.9, or about 10.

To help maintain the pH, in some aspects, the composition can further comprise an acid, a base, or combination of an acid and a base.

In some aspects, the detergent composition comprises an acid, which is any suitable compound with a pKa of less than about 10. In some aspects, the acid is an inorganic acid or an organic acid. Examples of an inorganic acid include hydrochloric acid, nitric acid, nitrous acid, sulfuric acid, sulfurous acid, phosphoric acid, boric acid, hydrobromic acid, hydroiodic acid, perchloric acid, and combinations thereof. In some aspects, the acid is a weak acid such that the acid has a pKa of 2 or greater (e.g., pKa is about 2 to about 10). Examples of a weak acid include, e.g., an organic acid or carbonic acid, hydrocyanic acid, phosphoric acid, sulfurous acid, nitrous acid, or a combination thereof.

In some aspects, the acid in the detergent composition is an organic acid, which in some instances can additionally act as a chelating agent. The organic acid can contain one or more (e.g., 1, 2, or 3) carboxylic acid groups, which can be used singly or in combination. For example, monocarboxylic acids include formic acid, acetic acid, propionic acid, butanoic acid, quinic acid, shikimic acid, lactic acid, sorbic acid, caproic acid, capyrylic acid, capric acid, lauric acid, and stearic acid. Di- and tricarboxylic acids include citric acid, isocitric acid, cis-aconitic acid, adipic acid, gluconic acid, glutaric acid, itaconic acid, ascorbic acid, succinic acid, malonic acid, malic acid, maleic acid, fumaric acid, tartaric acid, and oxalic acid. In some aspects, the detergent composition comprises citric acid.

In some aspects, the detergent composition comprises from about 1 wt % to about 10 wt % of acid (e.g., an organic acid, such as citric acid) relative to the total weight of the composition. For example, the acid can be present in an amount from about 1 wt % to about 8 wt %, about 1 wt % to about 5 wt %, about 1 wt % to about 3 wt %, about 1.5 wt % to about 10 wt %, about 1.5 wt % to about 8 wt %, about 1.5 wt % to about 5 wt %, about 1.5 wt % to about 3 wt %, about 2 wt % to about 10 wt %, about 2 wt % to about 8 wt %, about 2 wt % to about 5 wt %, about 2 wt % to about 3 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the composition.

In some aspects, the detergent composition comprises a base, which is any suitable compound with a pKb of about 1 to about 13. In some aspects, the base can be a Group I hydroxide, a Group II hydroxide, monoethanolamine, diethanolamine, triethanolamine, methyl diethanolamine, sodium tetraborate, trisodium phosphate, sodium carbonate, or a combination thereof. In other aspects, the base is a Group I hydroxide, a Group II hydroxide, sodium tetraborate, trisodium phosphate, sodium carbonate, or a combination thereof. In some aspects, the base can be a Group I hydroxide, such as sodium hydroxide, potassium hydroxide, or a combination of both.

In some aspects, the detergent composition comprises from about 1 wt % to about 10 wt % of base (e.g., a Group I hydroxide) relative to the total weight of the composition. For example, the base can be present in an amount from about 1 wt % to about 8 wt %, about 1 wt % to about 5 wt %, about 1 wt % to about 3 wt %, about 1.5 wt % to about 10 wt %, about 1.5 wt % to about 8 wt %, about 1.5 wt % to about 5 wt %, about 1.5 wt % to about 3 wt %, about 2 wt % to about 10 wt %, about 2 wt % to about 8 wt %, about 2 wt % to about 5 wt %, about 2 wt % to about 3 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the composition.

In some aspects, the detergent composition is substantially free of an organic base. At certain pH ranges, the amino acid (e.g., lysine or threonine) can act as a pH buffer. In an example, when the detergent composition comprises lysine or a salt thereof, and the pH of the detergent composition is greater than 7 to about 8.5, an additional base can be added to maintain the pH. However, when the detergent composition comprises lysine or a salt thereof, and the pH of the detergent composition is about 8.5 to about 10, then no other added base (e.g., an organic base) may be needed (e.g., the detergent composition is substantially free of a base other than lysine).

In some aspects, the detergent composition comprises a pH buffer (e.g., a basic buffer). The buffer can be any suitable composition that is water soluble and controls (i.e., maintains) the pH of the detergent composition within a pH of greater than 7 to about 10, as described herein. For example, the buffer can comprise a weak base (e.g., ammonia or ammonium hydroxide) and a salt of its conjugate acid (e.g., ammonium chloride, ammonium carbonate, etc.). In some aspects, the buffer comprises monobasic potassium phosphate or dibasic potassium phosphate.

In some aspects, the detergent composition can further comprise at least one additive. The additive is any suitable component that does not reduce the at least one amino acid's ability to scavenge chlorine. For example, the at least one (e.g., 1, 2, 3, 4, 5, or 6, etc.) additive can be selected from an anti-redeposition agent, a bleaching agent, a bleach activator, a chelating agent, an additional chlorine scavenger, a biocide, an optical brightener, and a combination thereof. Inert additives include, e.g., a fragrance, a dye, or a combination thereof.

In some aspects, the detergent composition comprises from about 1 wt % to about 10 wt % of a total amount of additives relative to the total weight of the composition. For example, the total amount of additives can be from about 1 wt % to about 8 wt %, about 1 wt % to about 5 wt %, about 1 wt % to about 3 wt %, about 1.5 wt % to about 10 wt %, about 1.5 wt % to about 8 wt %, about 1.5 wt % to about 5 wt %, about 1.5 wt % to about 3 wt %, about 2 wt % to about 10 wt %, about 2 wt % to about 8 wt %, about 2 wt % to about 5 wt %, about 2 wt % to about 3 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the composition.

In some aspects, the detergent composition comprises an anti-redeposition agent. In some aspects, the anti-redeposition agent is biodegradable. The anti-redeposition agent can be based on acrylic acid, e.g., a homopolymer of acrylic acid, a polycarboxylate based on acrylic acid, a copolymer of acrylic acid and polystyrene, or a copolymer of maleic acid and acrylic acid. Examples of a suitable anti-redeposition agent include, e.g., sodium polyacrylate, modified polyethylene glycol, styrene-acrylic acid copolymer, polyethylene imine, or a combination thereof. In some aspects, the anti-redeposition agent comprises sodium polyacrylate.

In some aspects, the detergent composition comprises from about 0.001 wt % to about 5 wt % of the anti-redeposition agent relative to the total weight of the composition. For example, the anti-redeposition agent can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the composition.

In some aspects, the detergent composition comprises a bleaching agent (e.g., chlorine or oxygen-releasing bleaching agents) and optionally a bleach activator. In some aspects, the bleaching agent comprises a hydrogen peroxide source as an oxygen-releasing bleaching agent. In some aspects, the hydrogen peroxide source comprises at least one inorganic perhydrate salt comprising a perborate salt, a percarbonate salt, a perphosphate salt, a persulfate salt, a persilicate salt, or a combination thereof. These salts can be counterbalanced by a Group I cation and/or Group II cation (e.g., sodium cation) to form, for example, an alkali metal percarbonate. In some aspects, the at least one inorganic perhydrate salt comprises sodium percarbonate.

In some aspects, the detergent composition comprises from about 0.001 wt % to about 5 wt % of a bleaching agent relative to the total weight of the composition. For example, the bleaching agent can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the composition.

In some aspects, the detergent composition comprises a bleach activator, which is any suitable compound that enables the release of oxygen from the bleaching agent. Examples of the bleach activator include, e.g., tetraacetylethylenediamine (TAED), sodium 3,5,5-tri-methyl hexanoyloxybenzene sulfonate (iso-NOBS), sodium nonanoyloxybenzene sulfonate (NOBS), sodium acetoxybenzene sulfonate (ABS), and pentaacetyl glucose. Bleach activators are described in U.S. Pat. No. 6,551,982, the disclosure of which is incorporated herein by reference in its entirety. In some aspects, the detergent composition comprises a bleaching agent (e.g., sodium percarbonate) and a bleach activator (e.g., tetraacetylethylenediamine (TAED)).

In some aspects, the detergent composition comprises from about 0.001 wt % to about 5 wt % of a bleach activator relative to the total weight of the composition. For example, the bleach activator can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the composition.

In some aspects, when a bleaching agent is present, a bleach catalyst can be further present in the detergent composition. The bleach catalyst can be a transition metal-containing catalyst, such as a Mn, Fe, Co, Ru, or Mo salen complexes or carbonyl complexes or Mn-, Fe-, Co-, Ru-, Mo-, Ti-, V-, and Cu-complexes with N-containing tripod ligands or Co-, Fe- Cu-, and Ru-ammine complexes.

Complexes of manganese in oxidation stage II, III, IV, or IV are particularly used and which contain one or more macrocyclic ligands with the donor functions N, NR, PR, O, and/or S. For example, a manganese-containing catalyst includes Mn(1,4,7-trimethyl-1,4,7-triazacyclononane)(OCH₃)₃—(PF₆), Mn(IV)₂(u-O)₃(1,4,7-trimethyl-1,4,7-triazacyclononane)₂-(PF₆)₂, Mn(III)₂(u-O)₁(u-OAc)₂(1,4,7-trimethyl-1,4,7-triazacyclononane)₂-(ClO₄)₂, Mn(IV)₄(u-O)₆(1,4,7-triazacyclononane)₄ —(ClO₄)₂, Mn(III)Mn(IV)₄(u-O)₁(u-OAc)₂-(1,4,7-trimethyl-1,4,7-triazacyclononane)₂-(ClO₄)₃, and mixtures thereof. Other suitable ligands include 1,5,9-trimethyl-1,5,9-triazacyclododecane, 2-methyl-1,4,7-triazacyclononane, 2-methyl-1,4,7-triazacyclononane, 1,2,4,7-tetramethyl-1,4,7-triazacyclononane, and mixtures thereof. Cobalt-containing catalysts include, for example, cobalt pentaamine chloride salts, such as [Co(NH₃)₅Cl]Cl₂.

In some aspects, the detergent composition comprises from about 0.001 wt % to about 5 wt % of a bleach catalyst relative to the total weight of the composition. For example, the bleach catalyst can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the composition.

In some aspects, the detergent composition comprises a chelating agent (i.e., a chelant) that serves to improve the cleaning action of the detergent by scavenging metal ions naturally found in water. Suitable examples of a chelating agent includes, e.g., citric acid, nitriloacetic acid, sodium tripolyphosphate, ethylenediaminetetraacetic acid, diethylenetriaminepentaacetic acid, tetrasodium glutamate diacetate, tetrasodium aspartate diacetate, tetrasodium iminodisuccinate, and combinations thereof.

In some aspects, the detergent composition comprises from about 0.001 wt % to about 5 wt % of a chelating agent relative to the total weight of the composition. For example, the chelating agent can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the composition.

In some aspects, the detergent composition comprises a chlorine scavenger in addition to the at least one amino acid. The chlorine scavenger is any compound that can react with chlorine or a chlorine-generating compound (e.g., hypochlorite) to eliminate or reduce the bleaching activity. In some aspects, the chlorine scavenger can also act as a corrosion inhibitor. Examples of a chlorine scavenger include, e.g., potassium nitrate, sodium nitrate, tetrasodium iminodisuccinate, tris (hydroxymethyl) aminomethane, 2-amino-2-methyl-1, 3-propanediol, 2-amino-2-ethyl-1, 3-propanediol, 2-amino-1-butanol, 1-amino-2-propanol, 2-amino-1-propanol, 2-amino-2-methyl-1-propanol, and combinations thereof. In some aspects, the chlorine scavenger can be tetrasodium iminodisuccinate.

In some aspects, the detergent composition does not comprise (e.g., is substantially free of) a chlorine scavenger other than the at least one amino acid. In other aspects, the detergent composition comprises from about 0.001 wt % to about 5 wt % of an additional chlorine scavenger relative to the total weight of the composition. For example, the additional chlorine scavenger can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the composition.

In some aspects, the detergent composition comprises a biocide, which is any suitable compound with antimicrobial (e.g., antibacterial, antiviral, antifungal) activity. In an aspect, the biocide can act as a preservative in the composition. Examples of a biocide include, e.g., dichloroisocyanuric acid, hydrogen peroxide, a quaternary ammonium compound, glutaraldehyde, tetrakis(hydroxymethyl)phosphonium sulfate (THPS), 2,2-dibromo-3-nitrilopropionamide (DBNPA), 2,2-dibromo-3-nitrilpropionamide, 2-(hydroxymethylamino)-ethanol, 2-bromo-2-nitropropane-1,3-diol, β-bromo-β-nitrostyrene, 1,2-dibromo-2,4-dicyanobutane (DBDCB), 2,2-dibromo-3-nitrilopropionamide (DBNPA), 3-iodo-2-propynylbutyl carbamate (IPBC), chlorthalonil, 1-bromo-3-chloro-5,5-dimethylhydantoin, 5-chloro-2-methyl-4-isothiazolin-3-one, 2-methyl-4-isothiazolin-3-one, 1,2-benzisothiazolin-3-one, and combinations thereof. In some aspects, the biocide can be 5-chloro-2-methyl-4-isothiazolin-3-one, 2-methyl-4-isothiazolin-3-one, 1,2-benzisothiazolin-3-one, or a combination thereof.

In some aspects, the detergent composition comprises from about 0.001 wt % to about 5 wt % of a biocide relative to the total weight of the composition. For example, the biocide can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the composition.

In some aspects, the detergent composition comprises an optical brightener (e.g., a fluorescent whitening agent), which is any suitable hydrophilic compound that absorbs ultra violet light and emits visible (e.g., blue-violet) light to make textiles appear brighter. The optical brightener can comprise a triazole, a stilbene, or a biphenyl group. Examples of the optical brightener include, e.g., 2,2′-(2,5-thienediyl)bis[5-(2-methyl-2-propanyl)-1,3-benzoxazole, 5,5′-((perfluorocyclopent-1-ene-1,2-diyl)bis(5-methylthiophene-4,2-diyl))bis(2-(6-methoxybenzo[d]thiazol-2-yl)-1,3,4-oxadiazole), 5,5′-((perfluorocyclopent-1-ene-1,2-diyl)bis(5-methylthiophene-4,2-diyl))bis(2-(6-methoxybenzo[d]thiazol-2-yl)-1,3,4-oxadiazole), 2′,7′-bis(5-(4-(tert-butyl)phenyl)-1,3,4-oxadiazol-2-yl)-N³,N³,N⁶,N⁶-tetraphenyl-9,9′-spirobi[fluorene]-3,6-diamine, N,N-diphenyl-4-(5-(4-(triphenylsilyl)phenyl)-1,3,4-oxadiazol-2-yl)aniline, ((4-((4-(5-(4-nitrophenyl)-1,3,4-oxadiazol-2-yl)phenyl)diazenyl) phenyl)azanediyl)bis(ethane-2,1-diyl) diacetate, ((4-((4-(5-(4-((E)-4-nitrostyryl)phenyl)-1,3,4-oxadiazol-2-yl)phenyl)diazenyl)phenyl)azanediyl)bis(ethane-2,1-diyl) diacetate, 4,4′-diamino-2,2′-stilbenedisulfonic acid, 4,4′-bis(benzoxazolyl)-cis-stilbene, and 2,5-bis(benzoxazol-2-yl)thiophene, and combinations thereof. In some aspects, the optical brightener can be 2,2′-(2,5-thienediyl)bis[5-(2-methyl-2-propanyl)-1,3-benzoxazole.

In some aspects, the detergent composition comprises from about 0.001 wt % to about 5 wt % of an optical brightener relative to the total weight of the composition. For example, the optical brightener can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the composition.

In some aspects, the detergent composition comprises a biocide, and a chelating agent as additives. In some aspects, the detergent composition comprises a biocide (e.g., 5-chloro-2-methyl-4-isothiazolin-3-one, 2-methyl-4-isothiazolin-3-one, 1,2-benzisothiazolin-3-one, or a combination thereof) and a chelating agent (e.g., 2,2′-(2,5-thienediyl)bis[5-(2-methyl-2-propanyl)-1,3-benzoxazole) as additives.

In an aspect, the detergent composition comprises water, at least one surfactant, at least one amino acid or salt thereof, and at least one enzyme. For example, the detergent composition comprises:
water;
about 3 wt % to about 65 wt % of at least one surfactant;
about 0.001 wt % to about 5 wt % of at least one amino acid or a salt thereof; and
about 0.01 wt % to about 5 wt % of at least one enzyme,
wherein the detergent composition has a pH of greater than 7 to about 10 (e.g., about 8 to about 10). The amounts of each component will be selected to provide a detergent composition comprising 100 wt % of the total composition.

In an aspect, the detergent composition consists essentially of water, at least one surfactant, at least one amino acid or salt thereof, and at least one enzyme. For example, the detergent composition consists essentially of:
water;
about 3 wt % to about 65 wt % of at least one surfactant;
about 0.001 wt % to about 5 wt % of at least one amino acid or a salt thereof; and
about 0.01 wt % to about 5 wt % of at least one enzyme,
wherein the detergent composition has a pH of greater than 7 to about 10 (e.g., about 8 to about 10). The amounts of each component will be selected to provide a detergent composition comprising 100 wt % of the total composition.

In an aspect, the detergent composition consists of water, at least one surfactant, at least one amino acid or salt thereof, and at least one enzyme. For example, the detergent composition consists of:
water;
about 3 wt % to about 65 wt % of at least one surfactant;
about 0.001 wt % to about 5 wt % of at least one amino acid or a salt thereof; and
about 0.01 wt % to about 5 wt % of at least one enzyme,
wherein the detergent composition has a pH of greater than 7 to about 10 (e.g., about 8 to about 10). The amounts of each component will be selected to provide a detergent composition comprising 100 wt % of the total composition.

In another aspect, the detergent composition comprises, consists essentially of, or consists of: water; about 3 wt % to about 65 wt % of at least one surfactant; and about 0.001 wt % to about 5 wt % of at least one amino acid or a salt thereof; wherein the detergent composition has a pH of greater than 7 to about 10 (e.g., about 8 to about 10).

In an aspect, the detergent composition comprises water, at least one anionic surfactant, at least one nonionic surfactant, at least one amino acid or salt thereof, at least one enzyme, an acid, a base, a biocide, and a chelating agent. For example, the detergent composition comprises:
water;
about 3 wt % to about 65 wt % of surfactants comprising at least one anionic surfactant and at least one nonionic surfactant;
about 0.001 wt % to about 5 wt % of at least one amino acid or a salt thereof;
about 0.01 wt % to about 5 wt % of at least one enzyme;
about 1 wt % to about 10 wt % of acid;
about 1 wt % to about 10 wt % of base;
about 0.001 wt % to about 5 wt % of a biocide; and
about 0.001 wt % to about 5 wt % of a chelating agent,
   wherein the detergent composition has a pH of greater than 7 to about 10 (e.g., about 8 to about 10). The amounts of each component will be selected to provide a detergent composition comprising 100 wt % of the total composition.

In an aspect, the detergent composition consists essentially of water, at least one anionic surfactant, at least one nonionic surfactant, at least one amino acid or salt thereof, at least one enzyme, an acid, a base, a biocide, and a chelating agent. For example, the detergent composition consists essentially of:
water;
about 3 wt % to about 65 wt % of surfactants comprising at least one anionic surfactant and at least one nonionic surfactant;
about 0.001 wt % to about 5 wt % of at least one amino acid or a salt thereof;
about 0.01 wt % to about 5 wt % of at least one enzyme;
about 1 wt % to about 10 wt % of acid;
about 1 wt % to about 10 wt % of base;
about 0.001 wt % to about 5 wt % of a biocide; and
about 0.001 wt % to about 5 wt % of a chelating agent,
   wherein the detergent composition has a pH of greater than 7 to about 10 (e.g., about 8 to about 10). The amounts of each component will be selected to provide a detergent composition comprising 100 wt % of the total composition.

In an aspect, the detergent composition consists of water, at least one anionic surfactant, at least one nonionic surfactant, at least one amino acid or salt thereof, at least one enzyme, an acid, a base, a biocide, and a chelating agent. For example, the detergent composition consists of:
water;
about 3 wt % to about 65 wt % of surfactants comprising at least one anionic surfactant and at least one nonionic surfactant;
about 0.001 wt % to about 5 wt % of at least one amino acid or a salt thereof;
about 0.01 wt % to about 5 wt % of at least one enzyme;
about 1 wt % to about 10 wt % of acid;
about 1 wt % to about 10 wt % of base;
about 0.001 wt % to about 5 wt % of a biocide; and
about 0.001 wt % to about 5 wt % of a chelating agent,
   wherein the detergent composition has a pH of greater than 7 to about 10 (e.g., about 8 to about 10). The amounts of each component will be selected to provide a detergent composition comprising 100 wt % of the total composition.

In an aspect, the detergent composition comprises water, at least one surfactant selected from sodium lauryl sulfate, a linear alkyl benzene sulfonate, an alcohol ethoxysulfate, a methyl ester sulfonate, a fatty alcohol ethoxylate, an alkoxylated methyl ester of fatty acid (e.g., a methyl ester ethoxylate), and coco fatty acid, lysine or a salt thereof, at least one enzyme, citric acid, sodium hydroxide, a biocide, and tetrasodium glutamate diacetate. For example, the detergent composition comprises:
water;
about 35 wt % to about 55 wt % of surfactants selected from sodium lauryl sulfate, a linear alkyl benzene sulfonate, an alcohol ethoxysulfate, a methyl ester sulfonate, a fatty alcohol ethoxylate, an alkoxylated methyl ester of fatty acid (e.g., a methyl ester ethoxylate), coco fatty acid, and a combination thereof;
about 0.1 wt % to about 2 wt % of lysine or a salt thereof;
about 0.1 wt % to about 5 wt % of at least one enzyme;
about 1 wt % to about 6 wt % of citric acid;
about 1 wt % to about 6 wt % of sodium hydroxide;
about 0.01 wt % to about 1 wt % of a biocide; and
about 1 wt % to about 5 wt % of tetrasodium glutamate diacetate,
   wherein the detergent composition has a pH of greater than 7 to about 10 (e.g., about 8 to about 10). The amounts of each component will be selected to provide a detergent composition comprising 100 wt % of the total composition.

In an aspect, the detergent composition consists essentially of water, at least one surfactant selected from sodium lauryl sulfate, a linear alkyl benzene sulfonate, an alcohol ethoxysulfate, a methyl ester sulfonate, a fatty alcohol ethoxylate, an alkoxylated methyl ester of fatty acid (e.g., a methyl ester ethoxylate), and coco fatty acid, lysine or a salt thereof, at least one enzyme, citric acid, sodium hydroxide, a biocide, and tetrasodium glutamate diacetate. For example, the detergent composition consists essentially of:
water;
about 35 wt % to about 55 wt % of surfactants selected from sodium lauryl sulfate, a linear alkyl benzene sulfonate, an alcohol ethoxysulfate, a methyl ester sulfonate, a fatty alcohol ethoxylate, an alkoxylated methyl ester of fatty acid (e.g., a methyl ester ethoxylate), coco fatty acid, and a combination thereof;
about 0.1 wt % to about 2 wt % of lysine or a salt thereof;
about 0.1 wt % to about 5 wt % of at least one enzyme;
about 1 wt % to about 6 wt % of citric acid;
about 1 wt % to about 6 wt % of sodium hydroxide;
about 0.01 wt % to about 1 wt % of a biocide; and
about 1 wt % to about 5 wt % of tetrasodium glutamate diacetate,
   wherein the detergent composition has a pH of greater than 7 to about 10 (e.g., about 8 to about 10). The amounts of each component will be selected to provide a detergent composition comprising 100 wt % of the total composition.

In an aspect, the detergent composition consists of water, at least one surfactant selected from sodium lauryl sulfate, a linear alkyl benzene sulfonate, an alcohol ethoxysulfate, a methyl ester sulfonate, a fatty alcohol ethoxylate, an alkoxylated methyl ester of fatty acid (e.g., a methyl ester ethoxylate), and coco fatty acid, lysine or a salt thereof, at least one enzyme, citric acid, sodium hydroxide, a biocide, and tetrasodium glutamate diacetate. For example, the detergent composition consists of:
water;
about 35 wt % to about 55 wt % of surfactants selected from sodium lauryl sulfate, a linear alkyl benzene sulfonate, an alcohol ethoxysulfate, a methyl ester sulfonate, a fatty alcohol ethoxylate, an alkoxylated methyl ester of fatty acid (e.g., a methyl ester ethoxylate), coco fatty acid, and a combination thereof;
about 0.1 wt % to about 2 wt % of lysine or a salt thereof;
about 0.1 wt % to about 5 wt % of at least one enzyme;
about 1 wt % to about 6 wt % of citric acid;
about 1 wt % to about 6 wt % of sodium hydroxide;
about 0.01 wt % to about 1 wt % of a biocide; and
about 1 wt % to about 5 wt % of tetrasodium glutamate diacetate,
   wherein the detergent composition has a pH of greater than 7 to about 10 (e.g., about 8 to about 10). The amounts of each component will be selected to provide a detergent composition comprising 100 wt % of the total composition.

In some aspects, the detergent composition is about two to four times (e.g., about 2×, about 2.5×, about 3×, about 3.5×, or about 4×) more concentrated than a standard detergent dose, which is typically about 1.5 fluid ounces per dose. In some aspects, the detergent composition is about 0.4 to about 0.8 fluid ounces (i.e., about 11.8 to about 23.7 ml) per dose. For example, the detergent composition can be about 0.5 to about 0.8 fluid ounces per dose, about 0.6 to about 0.8 fluid ounces per dose, about 0.7 to about 0.8 fluid ounces per dose, about 0.4 to about 0.7 fluid ounces per dose, about 0.4 to about 0.6 fluid ounces per dose, about 0.4 to about 0.5 fluid ounces per dose, about 0.4 fluid ounces per dose, about 0.45 fluid ounces per dose, about 0.5 fluid ounces per dose, about 0.55 fluid ounces per dose, about 0.6 fluid ounces per dose, about 0.65 fluid ounces per dose, about 0.7 fluid ounces per dose, about 0.75 fluid ounces per dose, or about 0.8 fluid ounces per dose, or any range or value between any two preceeding values fluid ounces per dose. In some aspects, the detergent composition is about 0.5 fluid ounces (i.e., about 14.8 ml) per dose. In some aspects, the detergent composition is about 0.6 fluid ounces (i.e., about 17.7 ml) per dose. In some aspects, the detergent composition is about 0.75 fluid ounces (i.e., about 22.2 ml) per dose.

In some aspects, the detergent composition is a liquid, including a liquid that is dispensed from a container upon use.

It was unexpectedly discovered that the amino acid in the detergent composition can act as a chlorine scavenger. Water from a municipal source can contain up to 4 ppm chlorine. In some aspects, the detergent composition can scavenge (e.g., reduce) chlorine to a concentration of 0 ppm in less than about 60 sec (e.g., less than about 55 sec, less than about 50 sec, less than about 45 sec, less than about 40 sec, less than about 35 sec, less than about 30 sec, less than about 25 sec, or less than about 20 sec) after initial contact (time=0 sec) with a 1 L sample of water that comprises up to 4 ppm (e.g., up to 3.5 ppm, up to 3 ppm, up to 2.5 ppm, up to 2 ppm, up to 1.5 ppm, or up to 1 ppm) chlorine. In some instances of this method, the water sample will be agitated after the addition of the detergent composition. In some aspects, the detergent composition can scavenge (e.g., reduce) chlorine to a concentration of 0 ppm in less than about 30 sec after contact with a 1 L water sample comprising up to 4 ppm chlorine.

In some aspects, the present disclosure is directed to a method of using the detergent composition of any of the foregoing aspects. For example, the detergent composition can be used in a method of removing soil from a textile (e.g., cleaning a textile, such as a fabric). In particular, the present disclosure is directed to a method of removing soil from a textile comprising contacting the textile with a composition comprising the detergent composition described herein and water to form a washing load. Optional steps include mixing (agitating) the washing load and composition, removing the composition to provide a clean textile, rinsing the clean textile with additional water, and isolating the clean textile. In some aspects, soils that are suitably removed using the detergent composition include, but are not limited to, oil-containing soils, carbohydrate-containing soils, protein-containing soils, tannin-containing soils, particulate soils, and combinations thereof.

In an aspect, the method is directed to protecting a color of a textile (e.g., fabric) comprising adding the detergent composition described herein to water to form a composition and reduce the chlorine level of the water; and contacting the textile with the composition to form a washing load. Optional steps include mixing (agitating) the washing load and composition, removing the composition to provide a clean textile, rinsing the clean textile with additional water, and isolating the clean textile.

The color level of a textile can be measured using any suitable technique, such as spectrophotometry. The color of a textile is protected when the color level of a textile from a starting point (e.g., day 0) and the color level of the same textile after 3 to 30 (e.g., 3 to 25, 3 to 20, 3 to 15, 3 to 10, or 3 to 5) washes (each wash corresponding to a day) with the detergent composition described herein differs by less than about 15% (e.g., less than about 10%, less than about 8%, less than about 5%, less than about 3%, less than about 2%, less than about 1%).

In some aspects of these methods, the method can be performed using a washing machine, a tergetometer, or an equivalent device. In some aspects of these methods, the textile is a fabric comprising a red, blue, or black dye. In some aspects of these methods, the water is hot or warm water. In some aspects of these methods, the water is cold water. In some aspects of these methods, the water is municipal water.

### EXAMPLES

These examples are provided for the purpose of illustration only and the embodiments described herein should in no way be construed as being limited to these examples. Rather, the embodiments should be construed to encompass any and all variations which become evident as a result of the teaching provided herein.

### Example 1

A formulation, i.e., Formula 1, was prepared with the components listed in Table 1.

TABLE 1

| | Raw | |
|---|---|---|
| | Material | Wt % of |
| Component | Activity | Formula |
| Water, demineralized | 100 | q/s to 100 |
| | | (about 39.33) |
| Citric acid | 50 | 4.5 |
| Sodium tetraborate 5H₂O | 100 | 0.5 |
| 50% NaOH | 50 | 2.4 |
| Fatty alcohol ethoxylate | 100 | 18 |
| (Laureth, 6 EO) | | |
| Sodium Lauryl Sulfate | 29 | 30 |
| Coconut Fatty Acid, Anti-redeposition | N/A | 5.28 |
| Polymer, Chelant, Preservative, Aqueous | | |
| Enzyme Solution (Protease, Amylase, | | |
| Mannanase blend) | | |

Formula 2 consisted of 99 parts of Formula 1+1 part of Lysine HCl. Formula 3 consisted of 99.5 parts of Formula 1+0.5 part of Lysine HCl.

The target dose of detergent per wash was 15.5 grams, and the estimated amount of water in a High Efficiency Washing Machine was 31.4 L. Proportionally, 0.5 grams of detergent was added into 1 L of water for benchtop scale.

With a starting chlorine concentration of either 1 ppm or 3 ppm in the water, the results in Table 2 were observed after adding 0.5 grams of Formula 1, 2, or 3 to 1 L of the chlorinated water.

TABLE 2

| | | Initial | Chlorine Concentration after | | | |
|---|---|---|---|---|---|---|
| | | Chlorine | Contact with Formula (ppm) | | | |
| | Solution | Concentration | 15 | 30 | 60 | 120 |
| Formula | Agitated | (ppm) | sec | sec | sec | sec |
| 1 (control) | Yes | 1 | | | 0.5 | 0.5 |
| 2 (inventive) | Yes | 1 | 0 | 0 | | |
| 3 (inventive) | Yes | 1 | 0 | 0 | | |
| 1 (control) | Yes | 3 | 3 | | 2.5-3 | 2.5-3 |
| 3 (inventive) | Yes | 3 | 0 | 0 | | |

### Example 2

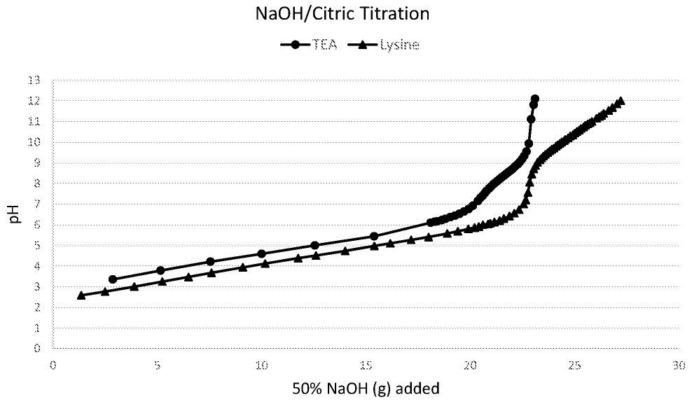

Two solutions of 350 grams of deionized water, 35 grams of 50% citric acid in water, and then 5 grams of either 85% triethanolamine (TEA) or 5.15% of lysine HCl (99% active) were prepared for a titration with 50% NaOH in water. This system simulates the main acidic and basic components of a liquid laundry detergent to measure what pH lysine can buffer effectively compared to the historical use of triethanolamine. The following results were observed, as set forth in Table 3 and FIG. 1.

TABLE 3

| 50% NaOH Added | TEA | 50% NaOH Added | Lysine |
|---|---|---|---|
| (grams) | pH | (grams) | pH |
| 2.87 | 3.35 | 1.36 | 2.58 |
| 5.16 | 3.78 | 2.5 | 2.76 |
| 7.55 | 4.21 | 3.9 | 3 |
| 10 | 4.59 | 5.24 | 3.25 |
| 12.55 | 5 | 6.5 | 3.47 |
| 15.39 | 5.44 | 7.6 | 3.67 |
| 18.1 | 6.1 | 9.1 | 3.94 |
| 18.3 | 6.15 | 10.17 | 4.12 |
| 18.42 | 6.17 | 11.75 | 4.38 |
| 18.64 | 6.23 | 12.6 | 4.51 |
| 18.81 | 6.29 | 14 | 4.73 |
| 19.04 | 6.37 | 15.4 | 4.97 |
| 19.27 | 6.44 | 16.16 | 5.1 |
| 19.48 | 6.53 | 17.16 | 5.27 |
| 19.7 | 6.64 | 18 | 5.4 |
| 19.92 | 6.76 | 18.89 | 5.58 |
| 20.12 | 6.92 | 19.4 | 5.68 |
| 20.36 | 7.15 | 19.9 | 5.8 |
| 20.48 | 7.3 | 20.2 | 5.86 |
| 20.59 | 7.4 | 20.4 | 5.91 |
| 20.69 | 7.53 | 20.6 | 6 |
| 20.78 | 7.64 | 20.85 | 6.04 |
| 20.9 | 7.76 | 20.95 | 6.07 |
| 20.99 | 7.85 | 21.15 | 6.13 |
| 21.1 | 7.96 | 21.4 | 6.2 |
| 21.2 | 8.04 | 21.6 | 6.3 |
| 21.3 | 8.12 | 21.87 | 6.42 |
| 21.4 | 8.21 | 22.1 | 6.56 |
| 21.5 | 8.29 | 22.33 | 6.73 |
| 21.62 | 8.38 | 22.55 | 7 |
| 21.72 | 8.46 | 22.65 | 7.2 |
| 21.81 | 8.54 | 22.76 | 7.56 |
| 21.93 | 8.63 | 22.84 | 8.06 |
| 22.04 | 8.72 | 22.94 | 8.45 |
| 22.15 | 8.83 | 23.03 | 8.7 |
| 22.27 | 8.93 | 23.12 | 8.87 |
| 22.37 | 9.04 | 23.21 | 9.03 |
| 22.48 | 9.18 | 23.33 | 9.15 |
| 22.58 | 9.33 | 23.41 | 9.24 |
| 22.69 | 9.55 | 23.5 | 9.33 |
| 22.8 | 9.93 | 23.59 | 9.41 |
| 22.91 | 11.11 | 23.7 | 9.5 |
| 23.03 | 11.81 | 23.8 | 9.58 |
| 23.1 | 12.1 | 23.9 | 9.66 |
| | | 24 | 9.72 |
| | | 24.1 | 9.81 |
| | | 24.18 | 9.87 |
| | | 24.28 | 9.94 |
| | | 24.37 | 10.01 |
| | | 24.49 | 10.08 |
| | | 24.55 | 10.14 |
| | | 24.68 | 10.21 |
| | | 24.78 | 10.3 |
| | | 24.9 | 10.35 |
| | | 25 | 10.45 |
| | | 25.1 | 10.52 |
| | | 25.21 | 10.59 |
| | | 25.3 | 10.67 |
| | | 25.42 | 10.74 |
| | | 25.51 | 10.82 |
| | | 25.62 | 10.89 |
| | | 25.72 | 10.94 |
| | | 25.82 | 11.01 |
| | | 26.04 | 11.16 |
| | | 26.17 | 11.24 |
| | | 26.28 | 11.3 |
| | | 26.38 | 11.4 |
| | | 26.62 | 11.54 |
| | | 26.8 | 11.68 |
| | | 27.02 | 11.86 |
| | | 27.2 | 12.01 |

As seen in FIG. 1, TEA was shown to buffer well at a pH of about 7 to about 9, whereas lysine acted as a buffer at pH of about 9 to about 12.

### Example 3

Formula 3 containing lysine, as described in Example 1, was adjusted to pH 9 with a 50% NaOH solution to provide Formula 4. The scavenging experiment of Example 1 was repeated for Formula 4, in which 0.5 g of Formula 4 were added to 1 L of water containing 3 ppm of chlorine under agitation. Under these conditions, the chlorine concentration was 0 ppm when tested at 15 sec and 30 sec.

### Example 4

Exemplary detergent compositions were prepared with the components listed in Table 4.

TABLE 4

| | Raw | | | | |
|---|---|---|---|---|---|
| | Material | Formula | Formula | Formula | Formula |
| Component | Activity | 5 | 6 | 7 | 8 |
| Water, softened | 100% | q/s to 100 | q/s to 100 | q/s to 100 | q/s to 100 |
| Fatty alcohol ethoxylate | 100% | 18 | 18 | 18 | 18 |
| (Laureth, 6 EO) | | | | | |
| Sodium lauryl sulfate | 29% | 30 | 30 | 30 | 30 |
| Citric acid | 50% | 4.5 | 4.5 | 4.5 | 4.5 |
| Sodium hydroxide | 50% | adjusted | adjusted | adjusted | adjusted |
| | | to pH 9 | to pH 9 | to pH 9 | to pH 9 |
| L-threonine | 98% | 1 | 0.5 | — | — |
| (MW = 119.12 g/mol) | | | | | |
| L-lysine HCl | 99% | — | — | 0.6 | 0.3 |
| (MW = 182.65 g/mol) | | | | | |
| Coconut Fatty Acid, Anti- | N/A | 5.28 | 5.28 | 5.28 | 5.28 |
| redeposition Polymer, | | | | | |
| Chelant, Preservative, | | | | | |
| Aqueous Enzyme Solution | | | | | |
| (Protease, Amylase, | | | | | |
| Mannanase blend) | | | | | |

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A detergent composition comprising water, at least one surfactant, at least one amino acid or a salt thereof, and at least one enzyme, wherein the detergent composition has a pH of greater than 7 to about 10.

2. The detergent composition of claim 1, wherein the at least one amino acid is selected from alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, any salt thereof, and a combination thereof.

3. The detergent composition of claim 2, wherein the at least one amino acid has a charged side chain or a polar uncharged side chain.

4. The detergent composition of claim 3, wherein the at least one amino acid is lysine, threonine, any salt thereof, or a combination of lysine and threonine including salts thereof.

5. The detergent composition of claim 1, wherein the at least one surfactant is an anionic surfactant, a cationic surfactant, a zwitterionic surfactant, a nonionic surfactant, or a combination thereof.

6. The detergent composition of claim 5, wherein the anionic surfactant comprises an alkyl sulfate, an alkyl sulfonate, a fatty acid salt, a bile acid salt, a glutamic acid salt, a cholic acid salt, a carboxylic poly(ethylene glycol) ether, a taurate, or a combination thereof.

7. The detergent composition of claim 5, wherein the cationic surfactant comprises a fatty amine salt, a fatty diamine salt, a coco amine alkoxylate, an alkoxylated amine, an alkoxylated diamine, fatty quaternary ammonium compound, a fatty amide quaternary ammonium compound, an alkoxylated quaternary ammonium compound, a benzalkyl quaternary ammonium compound, or a combination thereof.

8. The detergent composition of claim 5, wherein the zwitterionic surfactant comprises a betaine, a sulfonated quaternary ammonium compound, a phosphonated quaternary ammonium compound, a trialkylamine N-oxide, or a combination thereof.

9. The detergent composition of claim 5, wherein the nonionic surfactant comprises a fatty alcohol alkoxylate, a fatty acid alkoxylate, an alkyl phenol ethoxylate, an alkoxylated amine, an alkyl glucoside, a fatty amide alkoxylate, a diester of alkoxylated fatty acid, an alkoxylated methyl ester of fatty acid, a glycerol fatty ester, castor oil alkoxylate, an ethylene oxide-propylene oxide block copolymer, a phenol alkoxylate, or a combination thereof.

10. The detergent composition of claim 1, wherein the at least one enzyme comprises a protease, an amylase, a mannanase, a lactase, a lipase, a perhydrolase, an oxidoreductase, or a combination thereof.

11. The detergent composition of claim 1, wherein the detergent composition has a pH of about 8 to about 10.

12. The detergent composition of claim 1, wherein the composition further comprises an acid, a base, or combination of an acid and a base.

13. The detergent composition of claim 12, wherein the acid is an organic acid.

14. The detergent composition of claim 13, wherein the organic acid comprises citric acid.

15. The detergent composition of claim 12, wherein the base is a Group I hydroxide, a Group II hydroxide, sodium tetraborate, trisodium phosphate, sodium carbonate, or a combination thereof.

16. The detergent composition of claim 1, wherein the composition further comprises at least one additive selected from an anti-redeposition agent, bleaching agent, a bleach activator, a chelating agent, an additional chlorine scavenger, a biocide, an optical brightener, and a combination thereof.

17. The detergent composition of claim 16, wherein the bleaching agent comprises at least one inorganic perhydrate salt comprising a perborate salt, a percarbonate salt, a perphosphate salt, a persulfate salt, a persilicate salt, or a combination thereof.

18. The detergent composition of claim 1, wherein the detergent composition comprises water, at least one anionic surfactant, at least one nonionic surfactant, at least one amino acid or a salt thereof, at least one enzyme, an acid, a base, a biocide, and a chelating agent.

19. The detergent composition of claim 18, wherein the detergent composition comprises water, at least one surfactant selected from sodium lauryl sulfate, a linear alkyl benzene sulfonate, an alcohol ethoxysulfate, a methyl ester sulfonate, a fatty alcohol ethoxylate, an alkoxylated methyl ester of fatty acid, and coco fatty acid, lysine or a salt thereof, at least one enzyme, citric acid, sodium hydroxide, a biocide, and tetrasodium glutamate diacetate.

20. The detergent composition of claim 1, wherein the detergent composition scavenges chlorine to a concentration of 0 ppm in less than about 60 sec after contact with a 1 L water sample comprising up to 4 ppm chlorine.
